(19) United States
(12) Patent Application Publication
(10) Pub. No.: US 2019/0013692 A1
(43) Pub. Date: Jan. 10, 2019

(54) APPARATUS FOR STARTING AN ELECTRICALLY CRANKED ENGINE

(71) Applicant: DC SOLUTIONS AUSTRALIA PTY LTD, FAIRFIELD, VICTORIA (AU)

(72) Inventor: Sandy Dellevergini, Fairfield , Victoria (AU)

(21) Appl. No.: 16/066,251

(22) PCT Filed: Jul. 21, 2017
(86) PCT No.: PCT/AU2017/050753

§ 371 Date: Jun. 26, 2018

(30) Foreign Application Priority Data
Aug. 22, 2016 (AU) 2016219542
Dec. 12, 2016 (AU) 2016102104

(51) Int. Cl. H02J 7/34

(52) U.S. Cl. CPC H02J 7/345; B60R 16/033

(57) ABSTRACT

An apparatus for starting an electrically cranked engine includes a battery connection, a voltage increase circuit having an electrical input and output, and an electrical energy storage. The voltage increase circuit is connected at its input to the battery connection and at its output to the energy storage such that electrical energy at a relatively low voltage from a battery connected to the battery connection flows to the voltage increase circuit which increases the voltage of the electrical energy to a relatively high voltage, which then flows to the energy storage and is stored therein at the relatively high voltage. The voltage increase circuit may be a DC-to-DC boost converter. The energy storage is capable of storing electrical energy at about 12 V or 13 V, at least, or about 24 V or 25 V, at least, and may be capable of rapid charging and discharge.

### FIELD OF THE INVENTION

The present invention relates to the field of portable power sources. More particularly, but not exclusively, the invention relates to power sources used to jump start an electrically cranked engine such as an automobile engine.

### BACKGROUND TO THE INVENTION

Many types of engine are cranked with an electric starter motor. Particularly in vehicles and other forms of transport the starter motor is powered by an on board battery. Once the engine has started, a generator coupled to the engine typically recharges the battery so as to be ready for the next start. This arrangement is often incorporated into automobiles, boats, motorcycles, portable power generators and the like.

As is well known, all rechargeable batteries have a finite life beyond which the battery cannot be sufficiently charged (or cannot hold charge for a sufficient time) so as to provide the required electrical current to the starter motor for proper cranking of the engine. In modern automobiles in particular, the battery is exposed to a considerable parasitic load due to the heavy use of accessories such as stereo amplifiers, navigation systems, video displays and the like. In many instances, automobile drivers ignore the early signs of impending battery failure (such as slow cranking) and fail to replace the battery in good time. Typically a driver will crank the engine for longer than usual or execute multiple starting attempts, with these activities further exacerbating the already poor state of the battery. Eventually, the battery is depleted to the point that the engine cannot be started.

Thus, it is not uncommon for a driver to be stranded due to failure of the vehicle battery. In such circumstances, the driver must call for a roadside assistance service to “jump start” the engine, and then to arrange the battery to be replaced at a service center. Of course, this results in considerable inconvenience to the driver.

In other circumstances the battery is in serviceable condition but has not been charged for an extended period of time. Under these circumstances, the battery may lose charge to the point where insufficient electrical energy remains to effectively crank the engine. An example of such a circumstance is where a vehicle has not been driven for some time, and the battery therefore not charged by the vehicle generator. As is well known, in the absence of any charging from an external source (such as a trickle charger) the battery voltage decreases to the point where the engine cannot be effectively cranked.

Auxiliary battery devices of many types are known in the art to assist in cranking an engine where the vehicle battery is depleted. Such a device is often termed a “jump starter”, and typically includes some type of battery to store electrical energy. A temporary connection is made between the vehicle electrical system to the jump starter device to provide some or all of the power needed to turn the starter motor and crank the engine. Once the engine has been started, the vehicle's normal charging system will recharge the vehicle battery, allowing the auxiliary battery to be removed. If the vehicle charging system is functional, normal operation of the vehicle will restore the charge of the battery.

Prior art jump starters have a number of problems. One limitation is that the battery of the jump starter must be maintained in a charged state so as to ensure sufficient power is present in the device when required to start an engine. Thus, the jump starter must be periodically charged by connection to AC power or other external source. Motorists often fail to do this, leading to the inability to jump start a vehicle when required. Such problems often occur with lead-acid battery based jump starters. Lead-acid battery lose charge at a significant rate meaning that a motorist must go to some trouble to ensure that the unit is recharged at periodic intervals.

Some jump starters use lithium Ion batteries which tend to hold charge for longer periods, thereby requiring less attention to periodic recharging. While undoubtedly useful in that regard, lithium ion batteries raise significant safety issues. These batteries have very high energy densities and if a sufficient number of microscopic metallic contaminants converge, a major electrical short can develop with a sizable current flowing between the positive and negative plates. This causes the temperature in the battery to rise, leading to a thermal runaway whereby heat of the failing cell propagates to the next cell, causing further thermally instability. This process can proceed as chain reaction resulting in the complete destruction of the battery. A battery may catch fire, or even explode. Quite apart from the danger to a user, the transport of lithium ion jump starters by air to a consumer is problematic and costly given the need for carriers to conform to regulations such as the IATA Dangerous Goods Regulations.

Another problem is cold temperature charging. Many lithium-ion batteries cannot be charged below 0° C. Although appear to charge normally, plating of metallic lithium occurs on the anode while on a sub-freezing charge. The plating is permanent and cannot be removed. If done repeatedly, such damage can compromise the safety of the pack. The battery will become more vulnerable to failure if subjected to impact, crush or high rate charging.

A further problem arises with some jump starters that require careful operation on the part of the user. For example, in some jump starters it is necessary or at least desirable to carefully control the current discharge to the electrical circuit of the vehicle. Uncontrolled current discharge, can lead to damage of engine circuits and/or jump starter circuits. Moreover, uncontrolled current discharge can lead to a decreased chance of the engine being successfully started. These problems are especially applicable where the jump starter is capable of rapidly discharging at high currents, and also for jump starters that have a limited storage capacity so as to allow for only a single or several attempts at starting an engine.

Another problem with some jump starters is that an engine battery may have a functional or structural deficiency which may interfere with or prevent the jumpstarting process.

Yet a further problem arises in that some jump starters are not capable of functioning (or at least functioning optimally) will all or most vehicle types. The electrical systems of even similar vehicle types can have marked structural and functional differences leading to difficulties in designing a jump starter having broad applicability.

It is an aspect of the present invention to overcome or alleviate a problem of the prior art, or to provide a useful alternative to prior art jump starting apparatus.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides an apparatus for starting an electrically cranked engine, the apparatus comprising battery connection means, a voltage increase circuit having an electrical input and an electrical output, and electrical energy storage means, wherein the apparatus is configured such that the battery connection means is in electrical connection with the electrical input of the voltage increase circuit, and the electrical energy storage means is in electrical connection with the voltage output of the voltage increase circuit such that electrical energy at a relatively low voltage from a battery connected to the battery connection means flows to the voltage increase circuit which increases the voltage of the electrical energy to a relatively high voltage, and the electrical energy flows to the electrical energy storage means and is stored therein at the relatively high voltage.

In one embodiment of the first aspect, the voltage increase circuit is configured to increase voltage by at least about 1 V, 2 V, 3 V, 4 V, 5 V, 6 V, 7 V, 8 V, 9 V or 10 V.

In one embodiment of the first aspect, the voltage increase circuit is configured to increase voltage to more than about 12 V or 13 V; or more than about 24 V or 25 V, or at least about 36 V, or at least about 48 V.

In one embodiment of the first aspect, the voltage increase circuit is configured to increase voltage from as low as 3 V, 4 V, 5 V, 6 V, 7 V, 8 V, 9 V, or 10 V.

In one embodiment of the first aspect, the voltage increase circuit is a switched mode power converter.

In one embodiment of the first aspect, the voltage increase circuit is a DC-to-DC boost converter.

In one embodiment of the first aspect, the voltage increase circuit is an unregulated boost converter.

In one embodiment of the first aspect, the electrical energy storage means is capable of storing electrical energy at a voltage of at least about 12 V or 13 V or at least about 24 V or 25 V, or at least about 36 V, or at least about 48 V.

In one embodiment of the first aspect, the electrical energy storage means is configured to store static electrical energy, including storing the electrical energy in an electrical field.

In one embodiment of the first aspect, the electrical energy storage means is one or more capacitors.

In one embodiment of the first aspect, the one or more capacitors is/are an electrochemical capacitor.

In one embodiment of the first aspect, the one or more capacitors is/are a supercapacitor or an ultracapacitor.

In one embodiment of the first aspect, the electrical energy storage means is capable of being rapidly charged to virtually full capacity within less than about 5 seconds, 10 seconds, 15 seconds, 20 seconds, 25 seconds, 30 seconds, less than about 1 minute, less than about 2 minutes, less than about 3 minutes, less than about 4 minutes or less that about 5 minutes.

In one embodiment of the first aspect, the electrical energy storage means is capable of discharging most or virtually all stored electrical energy in less than around 5 seconds, 10 seconds, 15 seconds, 20 seconds, 25 seconds, 30 seconds, 35 seconds, 40 seconds, 45 seconds, 50 seconds, 55 seconds or 60 seconds.

In one embodiment of the first aspect, the electrical energy storage means is capable of providing electrical power to the starter motor of an electrically cranked engine at a current of at least about 100, 200, 300, 400, 500, 600, 700, 800, 900, 1000, 1100, 1200, 1300, 1400, 1500, 1600, 1700, 1800, 1900 or 2000 cold cranking amps.

In one embodiment of the first aspect, the electrical energy storage means is capable of storage electrical energy at a voltage of at least 12 V, 13 V, 14 V, 15 V, 16 V, 17 V, 18 V, 19 V, 20 V, 21 V, 22 V, 23 V, 24 V, 25 V, 26 V, 27 V, 28 V, 29 V, 30 V, 31 V, 32 V, 33 V, 34 V, 35 V, 36 V, 37 V, 38 V, 39 V, 40 V, 41 V, 42 V, 43 V, 44 V, 45 V, 46 V, 47 V, 48 V, 49 V, or 50 V.

In one embodiment of the first aspect, the electrical energy storage means is capable of storing sufficient electrical power so as crank an electrical cranked engine selected from the group consisting of a passenger vehicle engine, a truck engine, a motorcycle engine, an outboard motor engine, or an electricity generator engine.

In one embodiment of the first aspect, the apparatus comprises an ancillary system.

In one embodiment of the first aspect the ancillary system is configured to facilitate operation when the user is remote from the apparatus when the electrical energy storage means is charging or discharging.

In one embodiment of the first aspect, the ancillary system is a delay system configured to delay charging or discharging of electrical energy to or from the electrical energy storage means.

In one embodiment of the first aspect, the ancillary system is a remote actuation system configured to delay charging or discharging of electrical energy to or from the electrical energy storage means.

In one embodiment of the first aspect, the ancillary system comprises a system configured to automatically discharge the electrical energy storage means and/or automatically cease discharge of the electrical energy storage means.

In one embodiment of the first aspect, the ancillary system comprises a system configured to automatically commence charging of the electrical energy storage means after an earlier failed attempt at starting the electrically cranked engine.

In one embodiment of the first aspect, the ancillary system comprises a system to analyse a battery to which the apparatus is connected.

In one embodiment of the first aspect, the ancillary system comprises a system to prevent or control charging of the electrical energy storage means.

In one embodiment of the first aspect, the ancillary system comprises selection means configured to allow the user to select an engine type and/or a vehicle type, wherein the selection of an engine type and/or vehicle type facilitates operation when the user is remote from the apparatus when the electrical energy storage means is charging or discharging is.

In one embodiment of the first aspect, the ancillary system is operable so as to provide a learning mode, the ancillary system comprising detection means configured to detect a voltage and/or current of an electrical circuit of an electrically cranked engine to which the apparatus is attached, the detected voltage and/or current being used by the apparatus to facilitate operation when the user is remote from the apparatus when the electrical energy storage means is charging or discharging

In a second aspect of the invention there is provided a method of cranking an electrically cranked engine, the method comprising the steps of providing the apparatus of the first aspect, electrically connecting the battery connections means to a battery which is part of the electrical circuit of an electrically cranked engine, allowing electrical energy to flow from the battery to the apparatus for a period of time sufficient to charge the electrical energy storage means, and causing electrical energy to flow from the charged electrical energy storage means to the electrical circuit of the electrically cranked engine.

In one embodiment of the second aspect, and where the apparatus of the method comprises a delay system, the method comprises the step of actuating the delay system so as to delay electrical energy flowing from the electrical energy storage means to the starting circuit of the electrically cranked engine by n seconds, and actuating the starting circuit of electrically cranked engine after n seconds but before complete discharge of the electrical energy storage means so as to cause cranking of the electrically cranked engine.

In one embodiment of the second aspect, and where the apparatus of the method comprises a delay system, the method comprises the step of actuating the delay system so as to delay electrical energy flowing from the battery to the electrical energy storage means by n seconds, and actuating the starting circuit of the electrically cranked engine after charging of electrical energy storage means but before complete discharge of the electrical energy storage means so as to cause cranking of the electrically cranked engine.

In one embodiment of the second aspect, and where the apparatus of the method comprises a remote control system, the method comprises comprising the step of remotely controlling either or both the charging or discharging of the electrical energy storage means.

In a third aspect of the invention there is provided a system comprising the apparatus of the first aspect, and an electrically cranked engine, the electrically cranked engine comprising a starter motor and a battery, the system configured to allow electrical connection of the starter motor and the battery with the electrical energy storage means of the apparatus.

In one embodiment of the third aspect, the electrically cranked engine is a part of a passenger vehicle, a commercial vehicle, a truck, a motorbike, a personal watercraft or a generator.

### BRIEF DESCRIPTION OF THE DRAWINGS

FIG. 1A and 1B show block diagrams of a preferred apparatus of the present invention connected to a vehicle battery, the lines connecting blocks representing electrical conduits along which electrical energy may travel, with the arrows indicating the direction of movement. FIG. 1A shows the flow of electrical energy when the present apparatus is accepting electrical energy from a vehicle battery. FIG. 1B shows the flow of electrical energy when the present apparatus is discharging electrical energy into the electrical system of the vehicle.

FIG. 2 shows a schematic diagram of a preferred apparatus of the present invention. The diagram is divided into parts, with each part being shown in greater detail in FIGS. 3 to 10

FIG. 3 shows a schematic diagram of the circuitry marked “Part 1” in FIG. 2.

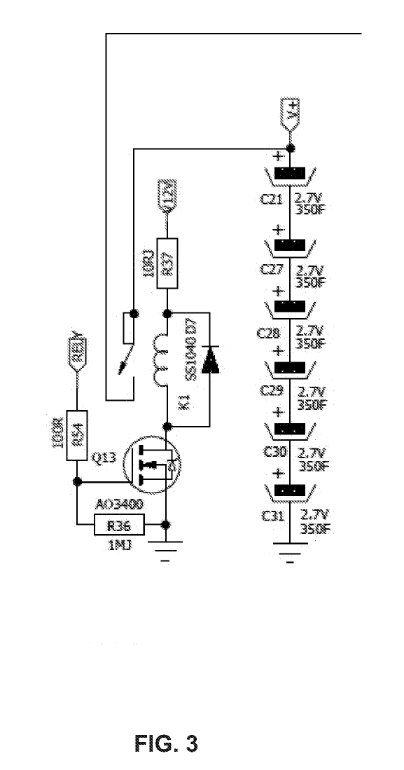

FIG. 4 shows a schematic diagram of the circuitry marked “Part 2” in FIG. 2.

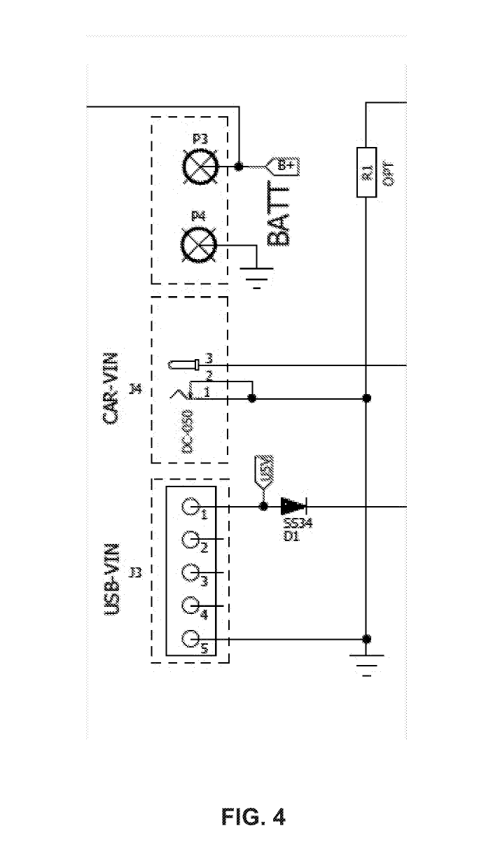

FIG. 5 shows a schematic diagram of the circuitry marked “Part 3” in FIG. 2.

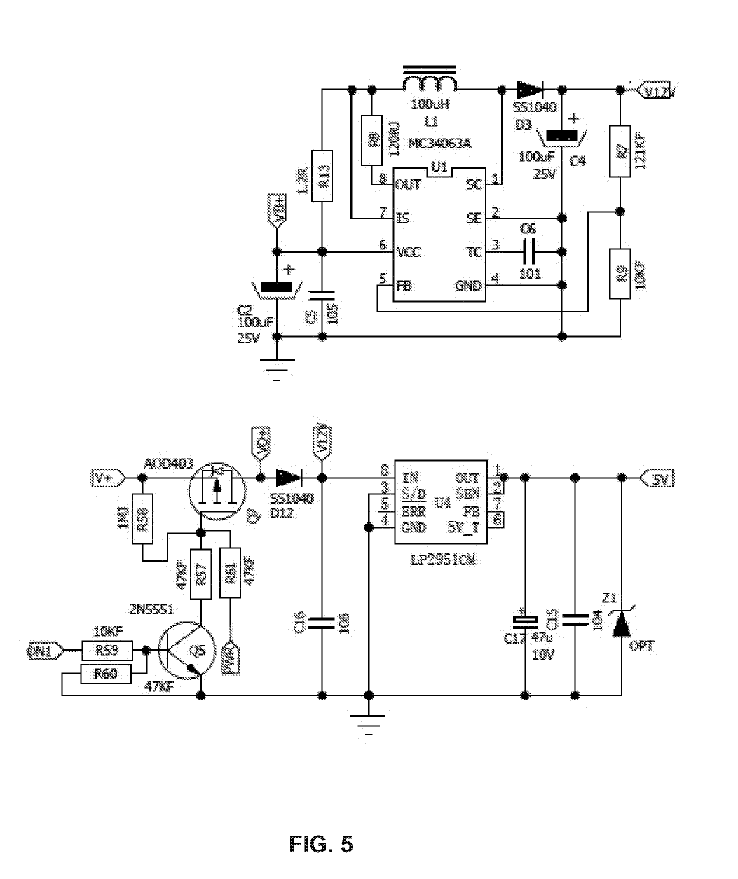

FIG. 6 shows a schematic diagram of the circuitry marked “Part 4” in FIG. 2.

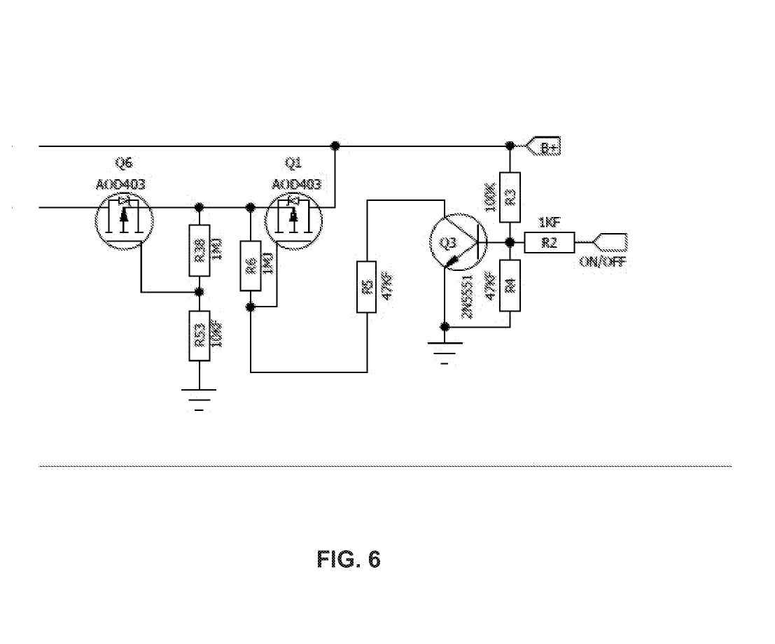

FIG. 7 shows a schematic diagram of the circuitry marked “Part 5” in FIG. 2.

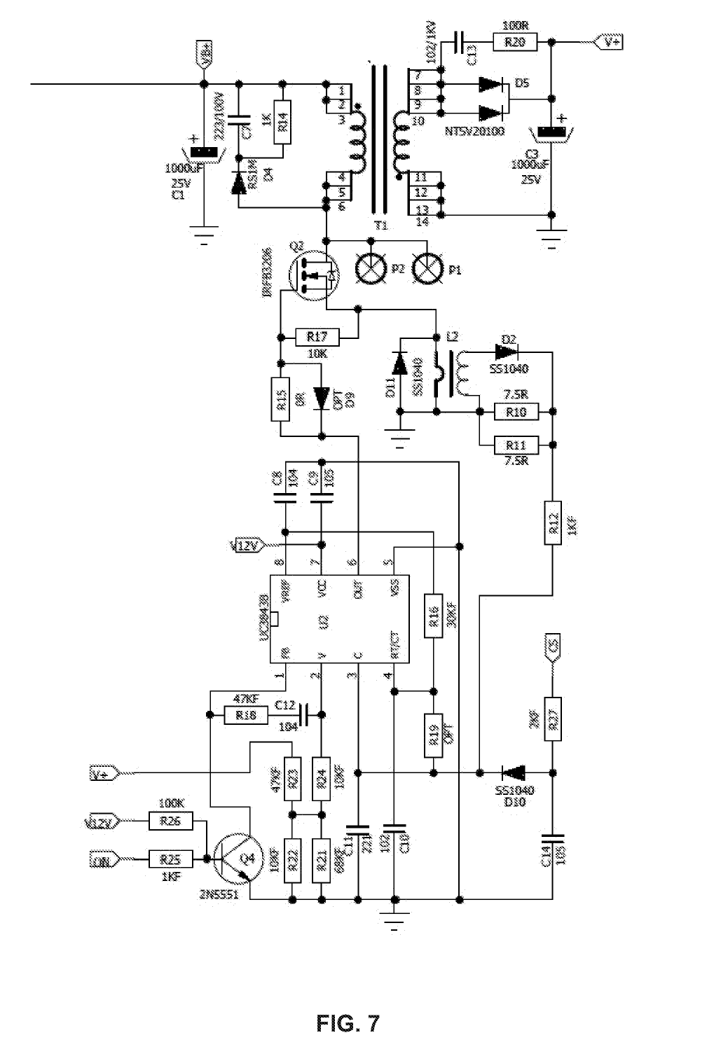

FIG. 8 shows a schematic diagram of the circuitry marked “Part 6” in FIG. 2.

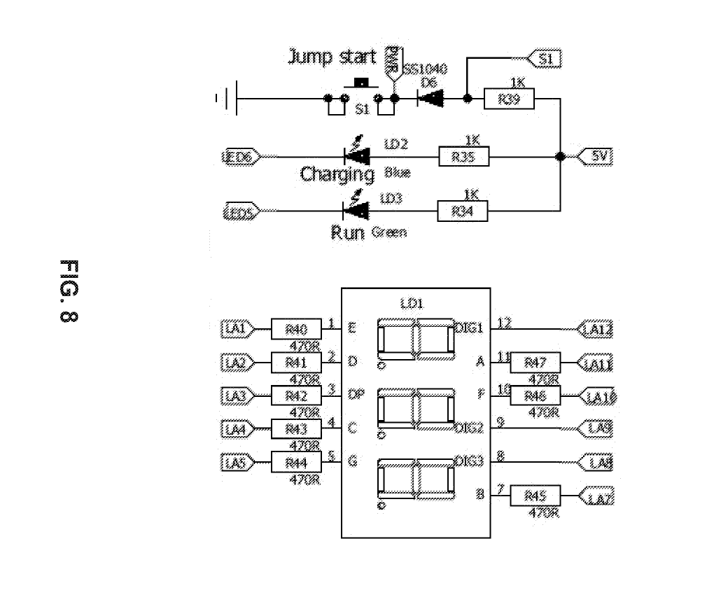

FIG. 9 shows a schematic diagram of the circuitry marked “Part 7” in FIG. 2.

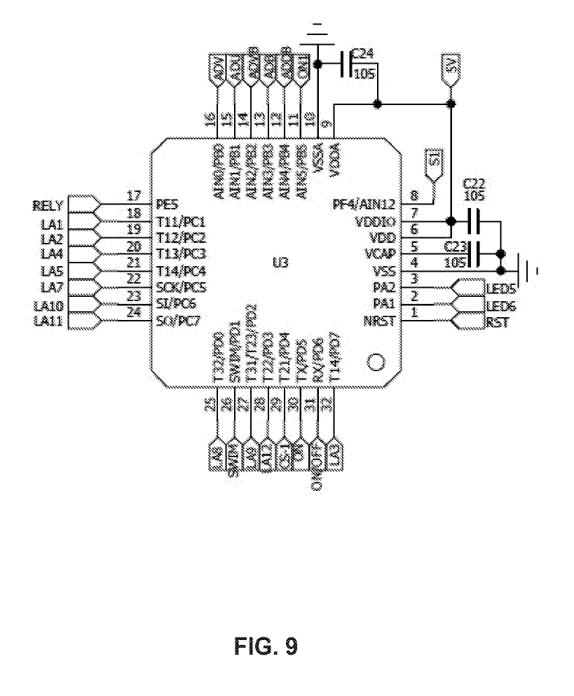

FIG. 10 shows a schematic diagram of the circuitry marked “Part 8” in FIG. 2.

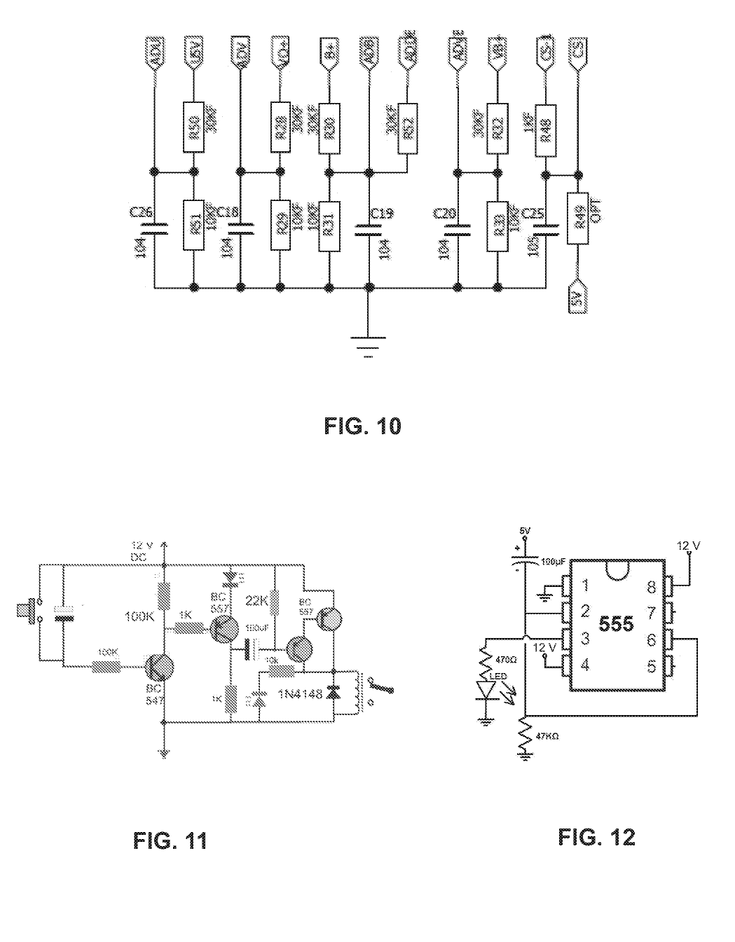

### DETAILED DESCRIPTION OF THE INVENTION

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects may lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and from different embodiments, as would be understood by those in the art.

In the claims below and the description herein, any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a method comprising step A and step B should not be limited to methods consisting only of methods A and B. Any one of the terms “including” or “which includes” or “that includes” as used herein is also an open term that also means including at least the elements/features that follow the term, but not excluding others. Thus, “including” is synonymous with and means “comprising”.

The present invention is predicated at least in part of the finding that the low voltage electrical energy remaining in a depleted battery of an electrically cranked engine may be used to jump start the engine by converting the low voltage electrical energy to a high voltage and storing the electrical energy at the higher voltage in a rapid charge/rapid discharge storage means such as a supercapacitor.

Accordingly, in a first aspect the present invention provides an apparatus for starting an electrically cranked engine, the system comprising battery connection means, a voltage increase circuit having an electrical input and an electrical output, and electrical energy storage means, wherein the apparatus is configured such that the battery connection means is in electrical connection with the electrical input of the voltage increase circuit, and the electrical energy storage means is in electrical connection with the voltage output of the voltage increase circuit such that electrical energy at a relatively low voltage from a battery connected to the battery connection means flows to the voltage increase circuit which increases the voltage of the electrical energy to a relatively high voltage, and the electrical energy flows to the electrical energy storage means and is stored therein at the relatively high voltage.

The present apparatus is particularly useful in jumpstarting a vehicle having a battery depleted to the point that it can no longer turn a starter motor so as to properly crank the vehicle engine. In such a situation, the battery connection means is attached to the battery (which remains connected to the vehicle electrical circuit) so as to allow low voltage electrical energy to flow from the depleted battery (which may be as low as 3 Volts) to the input of the voltage increase circuit which steps the voltage up to about 13 Volts for a passenger vehicle engine or about 25 Volts for a truck engine. The electrical energy passes (at the stepped-up voltage) to the storage means which accepts the energy until charged. Once sufficiently charged, the storage means then rapidly discharges the electrical energy via the battery connection means to vehicle electrical circuit. This provides instant electrical energy at sufficient voltage and current to turn the vehicle starter motor, thereby allowing cranking and starting of the engine.

The present invention is a departure from prior art jump starting devices that are slowly charged by connection of a lithium ion battery to an alternating current outlet (such as a household outlet) in preparation for use in the field. Such prior art contrivances have not sought to recover the electrical power present in a depleted battery still for the purposes of jumpstarting an engine, and instead accept only charging power at a higher voltage (such as 240 V) and must step-down the power to about 15 V to charge a passenger car battery or about 25 V for a truck battery.

The battery connection means may be any deemed suitable by the skilled person having the benefit of the present specification. Typically, the connection means will be easily attachable and removable from the poles of an electrochemical storage battery (such as a lead-acid vehicle battery) and may comprise a positive and a negative alligator-type clip to which wire of an appropriate gauge is attached. In other circumstances, the device may be substantially permanently or semi-permanently connect to the battery or other component of a vehicle electrical system. For example, the battery connection means may be connected to a component, or a wire or a terminal of the electrical system which is in direct or indirect electrical connection with the vehicle battery. In one embodiment, the battery connection means is configured to make electrical connection with a cigarette light socket of the vehicle, or any other power outlet in the vehicle cabin which is in electrical connection with the general electrical system of the vehicle.

The battery connection means is in electrical connection with the voltage increase circuit so as to allow electrical power to flow from the battery to the voltage increase circuit. As will be appreciated, a voltage increase circuit may be constructed using comparatively simple circuits. For example, switched-mode power supply circuit are known, such circuits incorporating a switching regulator for the efficient conversion of electrical power. Such circuits contain at least two semiconductors (a diode and a transistor) and at least one storage component (a capacitor or an inductor). The pass transistor of a switching-mode supply continually switches between low-dissipation, full-on and full-off states. Voltage regulation is achieved by varying the ratio of on-to-off time.

One type of useful type of switched-mode power supply is a boost converter (also known as a step-up converter) being is a DC-to-DC power converter configured to increase voltage (while decreasing current) from its input (supply, being the vehicle battery) to its output (load, being the electrical power storage means). To reduce voltage ripple, filters comprised of capacitors (possibly in combination with inductors) may be added to such a converter's output (load-side filter) and input (supply-side filter).

The voltage increase circuit may be a variant of the blocking oscillator that forms an unregulated voltage boost converter. The output voltage is increased at the expense of higher current draw on the input, but the integrated (average) current of the output is lowered.

Because of the ease with which boost converters can supply large over voltages, the circuit may include some regulation to control the output voltage, which may be achieved by a commercially available integrated circuit. In this way, the apparatus may be alternately configured to increase voltage up to that which is required to crank a vehicle engine (say, 15 V) or for a truck (say, 25 V).

While generally less efficient, a linear power supply may be used as a voltage increase circuit of the apparatus, whereby the output voltage is regulated by continually dissipating power in the pass transistor. Other types of voltage increase means useful in the context of the present apparatus will be apparent to the skilled person with all such means included in the ambit of the present invention.

The output (load) side of the voltage increase circuit is electrically connected to the electrical energy storage means. The energy storage means is matched to the voltage increase circuit such that the output of the voltage increase circuit is sufficient to charge the electrical energy storage means. For example, where the electrical energy storage means is configured to store electrical energy at 13 V, the voltage increase circuit is configured to output electrical energy at a voltage of at least 14 V or 15 V so as to ensure sufficient electromotive force to drive charging of the storage means.

In the context of the invention it will be appreciated that the electrical energy storage means should be capable of rapidly charging from the depleted battery. Thus, the user connects the apparatus to the depleted battery and waits for the storage means of the apparatus to charge. Given that the present apparatus will typically be used in a breakdown or emergency situation the electrical energy storage means is preferably capable of rapid charging. Storage means which rely purely on chemical reactions to store electrical energy (such as lead-acid and lithium ion batteries) are typically slow to charge requiring connection to a charging current for several hours at least. Accordingly, storage means that can charge in minutes will be generally preferred.

In one embodiment the storage means stores electrical energy statically, such as in the form of an electrical field. A convenient, useful and cost-effective means for storing a static electrical energy is in the form of a capacitor. These components are relatively inexpensive, generally compact and can be selected for a specific application.

Given the need to store the relatively large amount of electrical energy needed to crank a vehicle engine, it will be preferable to utilize one or more supercapacitors as the electrical energy storage means. The term “supercapacitor” is generally interchangeable with the terms “ultracapacitor” and “electric double-layer capacitor”. Supercapacitors are advantageous over electrolytic capacitors being capable of storing at least 10-fold the amount of electrical energy.

Supercapacitors do not use the conventional solid dielectric of electrolytic capacitors, and instead use electrostatic double-layer capacitance or electrochemical pseudocapacitance or a combination of both in a hydrid form. Thus, as used herein, the term “supercapacitor” is intended to include any double-layer capacitor which stores charge electrostatically (Helmholtz Layer), or any pseudocapacitor with stores charge electrochemically (Faradaically), or any hybrid capacitor which stores charge both electrostatically and electrochemically.

Electrostatic double-layer capacitors use carbon electrodes or derivatives with much higher electrostatic double-layer capacitance than electrochemical pseudocapacitance, achieving separation of charge in a Helmholtz double layer at the interface between the surface of a conductive electrode and an electrolyte. The separation of charge is of the order of several ångströms (0.3-0.8 nm),

Electrochemical pseudocapacitors use metal oxide or conducting polymer electrodes with a high amount of electrochemical pseudocapacitance. Pseudocapacitance is achieved by Faradaic electron charge-transfer with redox reactions, intercalation or electrosorption.

Hybrid capacitors, such as the lithium-ion capacitor, use electrodes with differing characteristics: one exhibiting mostly electrostatic capacitance and the other mostly electrochemical capacitance.

The electrolyte forms an ionic conductive connection between the two electrodes which distinguishes them from conventional electrolytic capacitors where a dielectric layer always exists, and the so-called electrolyte (e.g. MnO₂ or conducting polymer) is in fact part of the second electrode (the cathode, or more correctly the positive electrode). Supercapacitors are typically polarized by design with asymmetric electrodes, or, for symmetric electrodes, by a potential applied during manufacture.

Given the need for the delivery of instantaneous power at relatively high currents or peak currents, Class 4 supercapacitors are preferred as electrical energy storage means. As used herein, the definition of a Class 4 supercapacitor is according to the definition as per IEC 62391-1, IEC 62567and DIN EN 61881-3 standards.

One, two or more supercapacitors can be stacked in the present apparatus so as to provide the required voltage, storage capacity and current required to turn the starter motor of an electrically cranked engine. The supercapacitors may be provided in a collection of 2, 3, 4, 5, 6, 7, 8, 9, 10, 11 or 12. In such a collection, the supercapacitors are connected in series so as to provide a required voltage. For example, where a single supercapacitor is 2.7 V, six supercapacitors connected in series provides a total of 16.2 V which will be sufficient to crank the engine of passenger vehicle normally cranked by a 12 V lead-acid battery. Where the present apparatus is configured to jumpstart a truck, in excess of 25 V may be required to crank the engine and in which case twelve 2.7 V supercapacitors may be connected in series to provide a total electrical potential of 32.4 V.

The one or more supercapacitors may alone or together have a capacity of at least about 10 F, 20 F, 30 F, 40 F, 50 F, 60 F, 70 F, 80 F, 90 F, 100 F, 200 F, 300 F, 400 F, 500 F, 600 F, 700 F, 800 F, 900 F or 1000 F. Capacities in the range of 20 F to 200 F may be sufficient to crank smaller engines such as motorcycles, personal water craft, ride-on mowers, outboard motors and the like. Capacities in the range of 50 F to 500 F may be sufficient to crank engines for passenger vehicles and light commercial vehicles. Trucks, larger generators and other heavy duty machinery may require supercapacitors have capacities over 200 F.

Independently selectable to capacity, the one or more supercapacitors may alone or together have a voltage of at least about 13 V, 14 V, 15 V, 16 V, 17 V, 18 V, 19 V, 20 V, 21 V, 22 V, 23 V, 24 V, 25 V, 26 V, 27 V, 28 V, 29 V, 30 V, 31 V, 32 V, 33 V, 34 V, 35 V, 36 V, 37 V, 38 V, 39 V, 40 V, 41 V, 42 V, 43 V, 44 V, 45 V, 46 V, 47 V, 48 V, 49 V, or 50 V. Some engines are cranked by starter motors having

A further advantage of supercapacitors is the ability to function at temperatures lower than for which other modes of storage are operable. Thus, an apparatus of the present invention having a supercapacitor as the electrical energy storage means may be useful in sub-zero temperatures conditions.

Discharge of the electrical energy storage means so as to energize a starter motor may be commenced by the user closing a switch on the apparatus so as to complete a circuit comprising the electrical energy storage means and the starting circuit of the electrically cranked engine. Because the discharge of electrical energy may be rapid (as will be the case where the energy storage means is a supercapacitor) it may be necessary for a second person to be present in the vehicle cabin so as to commence cranking the engine by actuating the vehicle ignition system during current flow from the apparatus.

A problem with the present jump starters may relate to difficulties in using the apparatus. In some instances, the apparatus may provide for difficulty in a single person being able to jump start a vehicle. With a single operator there may be insufficient time to move from the engine bay (where the battery is located) to the vehicle cabin to properly time engine cranking with the discharge of electrical energy.

An ancillary system may be incorporated into the apparatus to avoid the need for a second operator. Thus, the ancillary system may be configured so allow for operation by a single operator so as to allow the operator to be remote from the device when the electrical energy storage means is charging or discharging.

In one form, the ancillary system is configured such that the apparatus automatically discharges when the electrical energy storage means moves into a charged state. In that case, the user connects the apparatus to a vehicle battery, and then returns to the vehicle cabin and waits the short time for the charging process to complete. Once the electrical energy storage means is charged above a predetermined threshold, the apparatus may emit an audible or visual signal to alert the user to commence cranking the engine.

As another example of an ancillary system, the apparatus may comprise a circuit which delays discharge. For example, the operator connects the apparatus to the vehicle battery and waits the short time for the electrical energy storage means to charge. The operator then actuates the delay circuit (which may delay discharge for about 5, 10, 15, 20, 25, 30, 35, 40, 45, 50, 55 60 seconds, 1 minutes, 2 minutes or 3 minutes) typically by pressing a button, or long-holding a button and then moves to the cabin to commence engine cranking. Again, an audible or visual signal may be emitted by the device to alert the operator that the delay has finished and the discharged has commenced. In one embodiment, the signal may be in the form of a countdown such that the operator can commence cranking to precisely coincide with the start of discharge.

A delay circuit may be configured alternately to delay charging the electrical energy storage means. Thus, the operator connects the apparatus to the vehicle battery actuates the delay circuit (which may delay charging for about 5, 10, 15, 20, 25, 30, 35, 40, 45, 50, 55 or 60 seconds) and then moves to the cabin to commence engine cranking. An audible or visual signal may be emitted by the device to alert the operator that the delay has finished and the charging has commenced. Upon reaching a charged stated, the apparatus may emit a second audible or visual signal to alert the operator that discharge has commenced. In one embodiment, the second signal may be in the form of a countdown such that the operator can commence cranking to precisely coincide with the start of discharge.

Given the benefit of the present specification, the skilled person is enabled to configure a time delay circuit such that the present apparatus is operable in a manner as described above. The delay circuit may control a relay which electrically connects the depleted vehicle battery to the charging circuit of the present apparatus or the charged electrical energy storage means to the depleted battery. An exemplary delay circuit operable in a 12 V system is shown at FIG. 11 herein.

In some embodiments, the delay function may be governed by an integrated circuit. For example, a simple “555” chip may be used as shown in FIG. 12 herein. This circuit works via the RC network. The combination of the resistor and capacitor forms the RC network. This network determines the length of time it takes to charge the capacitor. The circuit does not turn on immediately is because pin 2 (the trigger pin) is HIGH on power up. This is because the capacitor has not yet charged up. Until the capacitor charges, the pin remains HIGH. Since the trigger pin is active LOW, the output will be off until pin 2 reverts to LOW. As the capacitor charges and approaches the supply voltage to which it is connected, the voltage at pin 2 decreases. When the voltage at pin 2 gets below ⅓ of the supply voltage, the pin changes to LOW. When LOW, the output goes to HIGH and the LED (representative of the load) turns on. There is a delay of about 7 seconds with circuit as shown. Longer delays are provided with higher resistor and capacitor values.

The ancillary system may be configured to detect a voltage drop across the vehicle battery due to actuating the ignition, turning on headlights, actuating the brake lights, or actuating the horn. Upon detection of the voltage drop, the electrical energy storage means is triggered (for example by closing the charging circuit with a relay switch) to commence current discharge to the vehicle electrical system. It has been found that detection of a voltage drop upon actuation of the vehicle ignition will perfectly time the current discharge with the vehicle cranking so as to increase the probably of the engine successfully starting.

The present jump starter may rely only on the residual electrical power remaining in a flat battery to charge the supercapacitor(s). Where the vehicle battery is almost completely exhausted, power sufficient for only a single starting attempt may be available. In such situations, it is imperative that the current discharge is properly timed given that power for a second attempt at starting may not available.

The voltage drop may be detected with reference to a predetermined minimum voltage (such as 12 V, 11 V, 10 V, 9 V, 8 V, or 7 V) such that any excursion of the voltage across the battery below the predetermined minimum is considered a sufficient drop. Alternatively, the voltage drop may be detected with reference to a predetermined downward change in voltage (such as 0.1 V, 0.2 V, 0.3 V, 0.4 V, 0.5 V, 0.6 V, 0.7 V, 0.8 V, 0.9 V, 1 V, 2 V, 3 V, 4 V or 5 V), the downward change being calculated from the voltage as measured by the jump starter when connected across the battery terminals and current is initially discharged from the jump starter.

In some applications, the vehicle battery is not detected by the jump starter (because it is not present, or is bypassed, or is not functional as a battery due to damage or heavy sulfation) in which case the jump starter provides an override or bypass mode. In the override or bypass mode a voltage drop is not required to commence discharge of current from the jump starter, allowing for the discharge to be triggered manually. The manual trigger may be in the form a “run” button. The button may be configured as hardware, or as a menu item on a touch-sensitive screen of the jump starter. As discussed elsewhere herein, a delay circuit may be provided such that current is not discharged until elapse of a predetermined time period from manual triggering.

In one embodiment, the ancillary system may be configured to detect a voltage increase across the battery, the increase being of the magnitude typically generated when a vehicle engine is successfully started and electrical current is generated by the vehicle alternator.

The voltage increase may be detected with reference to a predetermined maximum voltage (such as 12 V, 13 V, 14 V, 15 V, 16 V, or 17 V) such that any excursion of the voltage across the battery above the predetermined maximum is considered sufficient. Alternatively, the voltage increase may be detected with reference to a predetermined upward change in voltage (such as 0.1 V, 0.2 V, 0.3 V, 0.4 V, 0.5 V, 0.6 V, 0.7 V, 0.8 V, 0.9 V, 1 V, 2 V, 3 V, 4 V or 5 V), the upward change being calculated from the voltage as measured by the jump starter when initially connected across the battery terminals and current is initially discharged from the jump starter.

The voltage increase may be used as an indication that the engine has been successfully started given that a running engine will generally cause electrical output from the alternator. The alternator output is typically at a voltage sufficient to charge the vehicle battery, and typically at least about 1 V or 2 V greater than the battery voltage.

Where the predetermined voltage or voltage increase is detected by the jump starter, discharge of current to the vehicle charging circuit is ceased. The cessation may be caused by the opening of relay switch to the vehicle charging circuit.

Applicant has discovered that significant variation exists between vehicles with respect to any voltage or change in voltage upwardly or downwardly that can be expected in the course of (i) actuating vehicle ignition, and (ii) the engine successfully starting. Accordingly, difficulty exists in configuring a jump starter so as to be capable of commencing and ceasing discharging at the required points in time when attempting to jump start a vehicle. Accordingly, in some embodiments of the invention the jump starter apparatus is provided with user selection means allowing a user to manually select a setting having preprogrammed voltage limits for voltage drop and voltage increase, or voltage threshold. The user selection means may be a button, or a switch or a menu displayed on a user interface of the jump starter apparatus,

The voltage limits programmed into the jump starter can be arrived at by the skilled person by an analysis of the many types of vehicle on the market. As will be appreciated, the skilled person may find that certain types of vehicles share similar voltage drops or voltage increases. Vehicles may be grouped according to such similarities and presented as a single option to the user for selection. For example, a single option may be selected from the options “small car”, “medium car”, “4WD vehicle” and “truck”. All or most vehicles in each class may share similar voltage drops or voltage increases upon starting, and a user can have a reasonable level of assurance that the jump starter will be operable with his/her vehicle so long as he correct class is chosen.

To improve the chance of operability, the jump starter may comprise a more complex user interface in the form of a menu-driven selection means on a visual display. The menu may allow guided selection by the user. A first level menu may provide for selection of a broad vehicle class, such as passenger car, motor cycle, off road vehicle, transport van, truck, or water craft. Upon selection from the first level menu, a second level menu is presented. Where “passenger car” is selected at the first level menu, the second level may provide options of “small sedan”, “medium sedan”, “large sedan”, “sports coupe”, and “sports utility vehicle”. Upon selection of “medium sedan” a third level menu providing the options of “European brand”, “American brand” and “Japanese brand” may be displayed. Upon selection of

“European brand” the jump starter utilizes previously programed voltage limits that are common to all or most medium sized European passenger sedans.

Such groupings may not be practically feasible, and in which case the automatic discharge and cessation of discharge function of the jump starter will be inoperable. As an alternative, the jump starter may be provided with the ability to store voltage limits for a large number of vehicles presently and historically sold. The user may allow a user to search for his/her car by way of display (for example, 2012 BMW 318) selection of which will load voltage limits known to be operable with that vehicle. As will be appreciated, with the introduction of new vehicles, it may be necessary to test each new vehicle as it is introduced into the market an effect regular firmware updates to the jump starter apparatus to include voltage limits of new models.

As an alternative to storing a set of voltage limits in the jump starter, the apparatus may be configured to comprise a “learning” mode. In learning mode, the jump starter is connected to the vehicle battery at a time when the vehicle battery is functional. The user then starts the car and the jump starter measures the voltage drop for that car upon actuation of the ignition. Once the vehicle starts, the jump starter measures the increase in voltage caused by the alternator output. These voltage are stored in the device in non-volatile memory and are used when the jump starter is used in the event of battery failure. By this approach, there is no need for the manufacturer to provide exhaustive voltage limits for each, or even most, cars on the road and to provide firmware updates.

In a further embodiment, the ancillary system is configured to provide an automatic restart function such that if the vehicle has not started after discharge of current from the jump starter then the electrical energy storage means commence recharging from what electrical energy is left in the vehicle battery. This situation may be detected by the jump starter by reference to (i) any voltage drop across the vehicle battery terminals as occurs when the ignition circuit is closed and the engine cranks and (ii) any voltage increase across the vehicle battery terminals as occurs when an engine starts and the alternator outputs a charging voltage. Thus, where a voltage increase does not follow a voltage drop (such as within 1, 2, 3, 4, 5, 6, 7, 8, 9 or 10 seconds) the circuit responsible for charging the energy storage means is automatically closed as to commence recharging of the jump starter in preparation for a second attempt at starting.

This embodiment provides significant advantage as it allows for the user to remain seated in the vehicle cabin and ready to actuate the ignition system for a second attempt at starting the vehicle. Typically, an audible sound will be emitted from the jump starter when the storage means have fully charged and the jump starter is ready for a second attempt. The audible sound is heard by the user, who then actuates the ignition for a second time. The audible sound may coincide with discharge of current from the jump starter, in which case the user must immediately actuate the ignition. Alternatively, the audible sound may signal to the user that the jump starter is ready for a second attempt, and in which case current is not discharged until a voltage drop is detected (as described supra) upon actuation of the ignition by the user.

In the absence of the automatic restart function a user is forced to return to the vehicle engine bay to manually restart charging of the energy storage means from the vehicle battery.

In one embodiment, the ancillary system comprises means to control charging current drawn from the vehicle battery. An advantage of this embodiment is that damage to a battery that is significantly depleted may be avoided by ceasing current draw once a predetermined lower voltage threshold is approached or breached before or during charging. For example, where a battery is detected by the jump starter to have a voltage of less than 3 V, then the jump starter may be configured to not commence charging of the storage means so as to prevent damage to the battery. Alternatively, the jump starter may display a visual warning of the possibility of battery damage on display and providing the user with the option of continuing with charging the storage means nevertheless.

In some circumstances, the vehicle battery may display an acceptable level of charge at the commencement of charging the storage means but in the course of charging the voltage approaches or breaches a predetermined minimum voltage. At that point, the jump starter may cease charging the storage means and display a warning to the user. Again, the jump starter may provide the user with the option of overriding the safeguard and allow the storage means to continue charging.

A further ancillary system that may be incorporated into the present jump starter, is a battery tester/analyzer. The testing/analysis may be conducted in any one or more of: before jump starting, during charging the storage means of the jump starter, or after the vehicle has been started. The battery/tester analyzer may measure voltage internal impedance/resistance, discharge rate, load, or any other relevant parameter of the battery. Such testing/analysis may be sufficient to provide the user with an indication as to whether or not the failure of the engine to start was due to the battery.

In some embodiments, the ancillary system may further comprise means to measure and assess the charging voltage as supplied by the vehicle alternator. Such measurement and assessment may show that the fault is with the vehicle charging system rather than the battery.

The present ancillary systems may be incorporated alone or in any number together in the apparatus and in any combination. The addition of each ancillary system provides incremental advantage to the apparatus overall.

As will be appreciated many of the ancillary systems require means for detecting a voltage in a circuit. Such means are very well known to the skilled artisan, and any such means known and deemed useful may be incorporated into these embodiments of the invention. The detected voltage is typically encoded in digital form and used by a processor of the jump starter to enable decisions (typically via software algorithmic means) to be made as to what electrical outcome results from what voltage or change in voltage is detected.

These ancillary systems are typically embodied in software, the software being held in non-volatile memory of the jump starter apparatus, the non-volatile memory being in data communication with a computer processor of the apparatus. Thus, in one aspect the present invention provides a set of computer-processor executable instructions configured to execute any method described herein, or to achieve any outcome desired herein, or to measure any electrical parameter as described herein, or to control any electrical parameter as described, or to allow any menu selection as described herein, or to allow input of any electrical parameter as described herein. Moreover, the computer-executable instructions may be configured to execute a decision-making algorithm to allow the present jump starter apparatus to function in any manner as described herein in an automatic or semi-automatic manner.

Another alternative for an ancillary system comprises remote control means (wired or wireless) configured to allow the operator to control the apparatus form within the cabin of vehicle during jumpstarting. The ancillary system may comprise a hand-held remote device with a radio transmitter configured to transmit a signal to a paired radio receiver within the apparatus, the receiver configured to actuate charging or discharging of the electrical energy storage means.

The present apparatus is typically configured in the form of a self-contained product, with all electronics encased in a housing so as to be substantially self-contained. The housing may be fabricated from a damage resistant plastic or a metal, however non-conductive housing are preferred to prevent shorting which may occur where the apparatus is disposed on or about a battery. Typically, wires forming part of the battery connection means of the apparatus extend from the main housing, each of the wires terminating in a battery post clip. Preferably, the apparatus is substantially sealed against the ingress of water. In this form, the apparatus may comprise electrical and electronic components such as a user-actuatable switch control the operation of the jump starter. A set of indicator lights may be provided to show the status of the internal electrical energy storage means. An integrated circuit controller may be incorporated to monitor the various components of the jump starter and show results on a display. The display may include, for example, a linear meter, a digital read out or a bar graph which may allow a user to monitor the operation of the jump starter, such as the status on the internal electrical energy storage means, the battery in a vehicle being jump started, or other parameter. A battery gauge such as a linear meter for a digital read out or a bar graph may be provided to display to the user the status of the internal and/or the external battery. The gauge or read out may be provided on a front surface of the housing.

In other embodiments, the apparatus is integral with a machine having the electrically cranked engine machine, and may include components which are normally present in the machine such as wiring, switches, electronic control units, and the like. For example, the apparatus may form an integral part of a vehicle, being a permanent or semi-permanent feature of the vehicle. The apparatus may be retrofitted to an existing vehicle or installed during manufacture. In such an installation, operation of the apparatus may be automatically controlled by the engine management system or other onboard processor such that the apparatus is caused to commence charging the electrical energy storage means when the battery voltage falls below a predetermined value, or upon any difficulty in cranking the engine. Once charged, upon actuation of the ignition system by the driver the electrical energy storage means is automatically discharged so as to facilitate cranking. It will be appreciated that in such an arrangement the present apparatus may form an assistive function to augment electrical energy supplied by the battery or to provide most or all of the electrical energy to crank the engine.

The present invention will now be more fully described by reference to the following preferred embodiments.

### PREFERRED EMBODIMENTS OF THE INVENTION

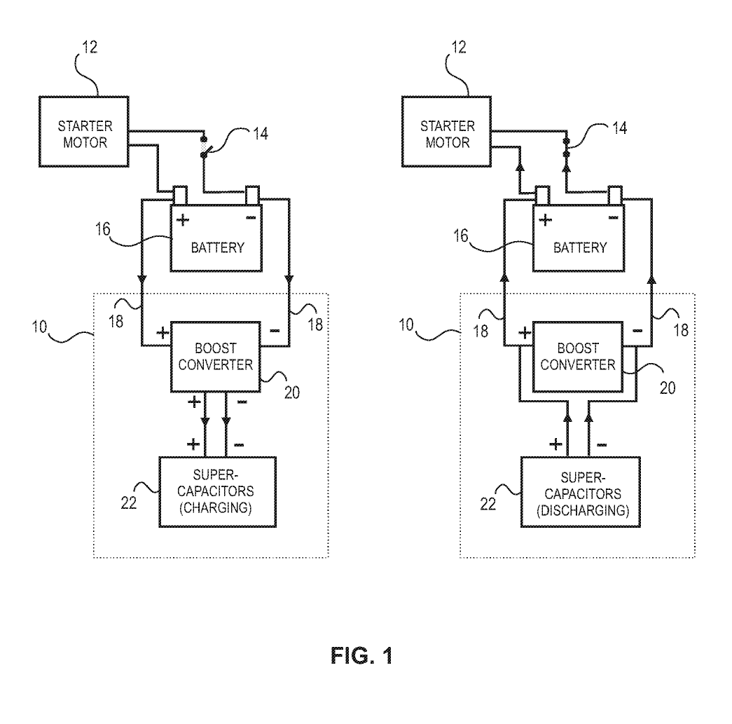

Reference is made to FIGS. 1A and 1B which show the flow of electrical energy where a preferred apparatus of the invention 10 is utilized to jumpstart a vehicle internal combustion engine (not shown) which is cranked by a starter motor 12 by actuation of ignition switch 14. The vehicle battery 16 is in electrical connection with the ignition switch 14. The apparatus 10 is in electrical connection with the battery 16 via the battery connection means 18. The apparatus has a boost converter 20 configured to increase the battery voltage to a level where the battery can charge the supercapacitors 22 of the apparatus 10. Thus, the battery 16 is in electrical connection with the supply (input) side of the boost converter 18.

FIG. 1A shows the situation where the battery 16 is depleted and the operator has connected the battery connection means 18 to the battery terminals. The ignition switch 14 is in the “off” position thereby isolating the starter motor 12 from the battery 16. In this preferred embodiment, the battery has a very low level of stored electrical energy, the voltage being 5 V as measured across the terminals. Upon connection of the apparatus 10 electrical energy flows from the battery 16 to the supply side of the boost converter 18, in the direction as indicated by the arrows. The boost converter steps-up the voltage to 18 V on the output (load) side, this being sufficient to rapidly charge the supercapacitors 22 to a voltage of 15.6 V.

An LED indicator (not shown) lights when the voltage reaches 15.6 V, at which time the operator actuates a switch (not shown) of the apparatus to connect the supercapacitors to the battery 16. This situation is shown in FIG. 1B the arrows indicating the flow of electrical energy to the battery 16. At this point, the potential across the battery terminals is 15.6 V. The operator closes the vehicle ignition switch 14 so as to electrically connect the starter motor 12 to the battery 16 terminals, and in turn the charged supercapacitors 22. Electrical energy flows from the supercapacitors 22 in the direction indicated by the arrows so as to cause the starter motor 12 to crank the vehicle engine (not shown).

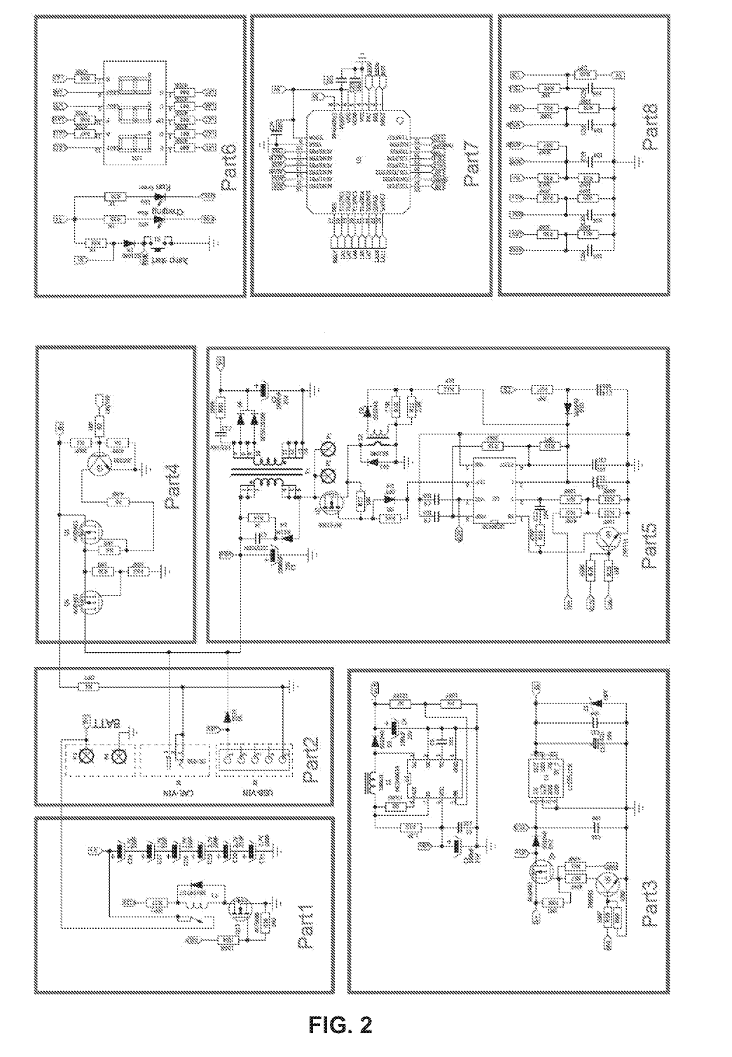

Reference is made to FIG. 2 which shows the overall schematics of a preferred vehicle jump starter of the present invention. This embodiment is configured to be operable in the context of a passenger vehicle having a standard 12 V electrical system, and is rated at 500 A max.

The operation of the overall apparatus will be described by reference to component parts 1 to 8.

Part 1: The Device Start Module

This part comprises the following components: R54, R36-R37, Q13, D7, K1, C27-C31, C21. When pressing down the Start button, pin 17 of MCU U3 will send a signal to the gate of MOSFET Q13 through R54 to make Q13 turn on and then the V12V (from Part 3) will pass through R37, the coil of Relay K1, the Drain and the Source of MOSFET Q13 to the ground; The relay K1 will be closed because the current passed through its coil. The V+ on the super capacitors will pass through the contact point of Relay K1 and sends the super current to B+ of the vehicles battery which provides current to start the engine.

Part 2: The Device Input/Output Ports

The device contains built in multi input and output ports for charge and discharge. P3-P4 is the input/output port for large current charging to this device or large current discharging from the super capacitor to the vehicle battery. J3 is a port for connecting a USB cable to charge the device. Diode D1 is to protect the external USB against flow back current to the USB input. J4 is a port for connecting a 12V cigarette plug lead to charge the device. This device will accept charging current from the external USB power source, or vehicle cigarette plug power source, a vehicles battery or any other 12v battery. When charged up to a predetermined voltage level, it will be ready to jump start a vehicle. The voltage (V+) is supplied to vehicles battery via the device start module (Part 1).

Part 3: The Device Auxiliary Power Source Module

It comprises of the following components: C2, C4-C6, R7-R9, R13, L1, D3, U1, C15-C17, R57-R61, Q5, Q7, D12, U4. The 12V power source is supplied by the control loop of C2, C4-C6, R7-R9, R13, L1, D3, U1. It will provide a 12V source to the power circuit and control circuit.

As long as VB+ is above 3V, it can provide a stable 12V power source.

If VB+is above 3V, VB+is supplied the power source to the Pin 6 (VCC pin) of U1 through the filter capacitor of C2 and C5. The voltage rises up by R13, L1, U1, D3 and C4 and then stabilises at 12V;

If there is a 5V power source to the MCU U3 or LED digital meter, it is detected by the 15-C17, R57-R61, Q5, Q7 (MOSFET), D12, U4.

V12V is filtered by C16 and by U4 to stabilise the voltage. It is further filtered by C15 and C17 to provide a stable 5V power source.

If there is no input power source to the device, V+ on the super caps will control the V12V via Q5 and Q7. If there is no power source or button press detection after 5 seconds the MCU will go to sleep. Pin 11 of the MCU will generate a low potential voltage which will control R59, Q5, Q7 and close V12V to decrease the stand-by power consumption.

Part 4: Input/Output Clamps Reverse Protection Module and Spark Free Protection Module.

In case the input/output clamps are connected reverse polarity to the battery, the MOSFET of Q1 and Q6 will not turn on. This is to protect the components from damage; while the clamps are connected to the battery terminals, the voltage of B+ goes through Q1 and Q6 and there is a delay operation in the circuit. Firstly it turns on Q3, then turns on Q1 and then turns on Q6. This delay will wait for the clamps to be firmly contacted/connected to the terminals of battery to prevent/reduce sparking.

Part 5: The Charging Circuit Module

This part comprises the following parts and components: C1,T1,C3,D5,Q2,L2,U2,Q4,D4,D2,D10-D11,R14-R27,R10-R12,C7-C14, The device will realise the voltage-rise and charge up the super cap by these components and parts.

V12V provides the power source to the Pin 7 of U2 (UC3843IC). Pin 6 of U2 delivers PWM signal to drive Q2 (MSFET) to switch ON or OFF through R5. VB+ goes through the Primary of T1 (transformer) and D,S of Q2, the primary of T1 has current flow. Then VB+ will be raised up by T1 and rectified by D5 (diode) and filtered by C3 to then charge up the V+ of the supercapacitor. Pin 30 of MCU U3 will deliver an ON/OFF signal to control Q4 switch, further control U2, to detect the charging circuit is working or stopped; The pin 29 of MCU U3 will deliver a PWM signal to the Pin 3 of U2 through R27 and D10, to detect and control the charging current level.

Part 6: LED Indication And Button Operation Control Circuit Module

LD1 is a digital display meter. It will display input voltage, the super cap voltage. The LED condition, LD2 is a charge indication light, indicating the start status: The LD2 flash to indicate the super cap is accepting the charging current, the LD2 ON or flashing to indicate the super cap is fully charged and ready for starting the vehicle. LD3 is a start status indication, LD3 flash is indicated the device waiting for start (during the period of delay start), the LD3 ON is indicated the device is in the process of starting vehicle. S1 is start button, Press the S1, delay for 5 seconds and then start vehicle.

Part 7: The Central Control Unit

This part comprises C22-C24 and U3. U3 is a microchip, and is the main control section which controls the charge, start, voltage detection, led indication etc.

Part 8: The Voltage Detection Module

This part comprises the following components: R28-R33, R50-R52, C18-C20, C26, detailed explanations as below: R50 and R51 is the USB detection circuit. When the input source is from USB, it will send the USB voltage to the Pin 15 of U3 MCU and LD1 digital meter will display USB input voltage; R28 and R29 is super cap detection circuit, when the super cap is accepted the charging current, it will send the super cap voltage to the Pin 16 of MCU, and LD1 will display super cap voltage; R30 and R31 is clamps (connected to vehicle battery) voltage detection circuit, when input source is vehicle battery and detected the battery voltage, it will send this voltage to the Pin 13 of MCU and the LD1 digital meter will display the input vehicle battery voltage. R32 and R33 is the cigarette plug source detection circuit, when the input is a cigarette plug voltage is detected, it will send this voltage to the Pin 14 of MCU and LD1 digital meter will display the cigarette plug voltage input; further, R52 will send the input vehicle battery voltage to the Pin 12 of MCU, if reversed clamps to vehicle battery, the LD1 will display Faulty and remind to reverse connection on the battery clamps.

In the description provided herein, numerous specific details are set forth. However, it is understood that embodiments of the invention may be practiced without these specific details. In other instances, well-known methods, structures and techniques have not been shown in detail in order not to obscure an understanding of this description.

It is not represented that all embodiments of the invention have all advantages discussed herein. Indeed some embodiments may have only a single advantage. Other embodiments may provide no advantage whatsoever and merely provide a useful alternative to the prior art.

In the following claims, any of the claimed embodiments can be used in any combination.

1. An apparatus for starting an electrically cranked engine, the apparatus comprising:
a battery connection;
a voltage increase circuit having an electrical input and an electrical output; and
an electrical energy storage, wherein the apparatus is configured such that the battery connection is in electrical connection with the electrical input of the voltage increase circuit, and the electrical energy storage is in electrical connection with the electrical output of the voltage increase circuit such that electrical energy at a relatively low voltage from a battery connected to the battery connection flows to the voltage increase circuit which increases the voltage of the electrical energy to a relatively high voltage, and the electrical energy flows to the electrical energy storage and is stored therein at the relatively high voltage.

2. The apparatus of claim 1 wherein the voltage increase circuit is a DC-to-DC boost converter.

3. The apparatus of claim 1 wherein the electrical energy storage means is capable of storing electrical energy at a voltage of at least about 12 V.

4. The apparatus of claim 1 wherein the electrical energy storage comprises one or more capacitors.

5. The apparatus of claim 4 wherein the electrical energy storage comprises a supercapacitor or an ultracapacitor.

6. (canceled)

7. (canceled)

8. The apparatus of claim 1 wherein the electrical energy storage is capable of storing sufficient electrical power so as to crank an electrically cranked engine selected from the group consisting of a passenger vehicle engine, a truck engine, a motorcycle engine, an outboard motor engine, or an electricity generator engine.

9. The apparatus of claim 1 comprising an ancillary system.

10. The apparatus of claim 9 wherein the ancillary system is configured to facilitate operation when a user is remote from the apparatus when the electrical energy storage is charging or discharging.

11. The apparatus of claim 9 wherein the ancillary system comprises a delay system configured to delay charging or discharging of electrical energy to or from the electrical energy storage.

12. The apparatus of claim 9 wherein the ancillary system comprises a remote actuation system configured to allow for remote control of charging or discharging of electrical energy to or from the electrical energy storage.

13. The apparatus of claim 9 wherein the ancillary system comprises a system configured to automatically discharge the electrical energy storage and/or automatically cease discharge of the electrical energy storage.

14. The apparatus of claim 9 wherein the ancillary system comprises a system configured to automatically commence charging of the electrical energy storage after an earlier failed attempt at starting the electrically cranked engine.

15. The apparatus of claim 9 wherein the ancillary system comprises a system to analyse the battery to which the apparatus is connected.

16. The apparatus of claim 9 wherein the ancillary system comprises a system to prevent or control charging of the electrical energy storage.

17. The apparatus of claim 10 wherein the ancillary system comprises selection means configured to allow the user to select an engine type and/or a vehicle type, wherein the selection of an engine type and/or vehicle type facilitates operation when the user is remote from the apparatus when the electrical energy storage is charging or discharging.

18. The apparatus of claim 9 wherein the ancillary system is operable so as to provide a learning mode, the ancillary system comprising a voltage or current detector configured to detect a voltage and/or current of electrical circuit of the electrically cranked engine to which the apparatus is attached, the detected voltage and/or current being used by the apparatus to facilitate operation when the user is remote from the apparatus when the electrical energy storage is charging or discharging.

19. A method of cranking an electrically cranked engine, the method comprising
providing an apparatus for starting an electrically cranked engine, the apparatus comprising a battery connection, a voltage increase circuit having an electrical input and an electrical output, and an electrical energy storage, wherein the apparatus is configured such that the battery connection is in electrical connection with the electrical input of the voltage increase circuit, and the electrical energy storage is in electrical connection with the electrical output of the voltage increase circuit such that electrical energy at a relatively low voltage from a battery connected to the battery connection flows to the voltage increase circuit which increases the voltage of the electrical energy to a relatively high voltage, and the electrical energy flows to the electrical energy storage and is stored therein at the relatively high voltage,
electrically connecting the battery connection to the battery which is part of an electrical circuit of the electrically cranked engine,
allowing electrical energy to flow from the battery to the apparatus for a period of time sufficient to charge the electrical energy storage, and
causing electrical energy to flow from the charged electrical energy storage to the electrical circuit of the electrically cranked engine.

20. The method of claim 19, wherein the apparatus comprises an ancillary system, and the method comprises actuating the ancillary system.

21. The method of claim 20 wherein the ancillary system comprises a delay system configured to delay charging or discharging of electrical energy to or from the electrical energy storage, and the method comprises
actuating the delay system so as to delay electrical energy flowing from the electrical energy storage to a starting circuit of the electrically cranked engine by n seconds, and actuating the starting circuit of electrically cranked engine after n seconds but before complete discharge of the electrical energy storage so as to cause cranking of the electrically cranked engine.

22. (canceled)

23. A system comprising:
an apparatus for starting an electrically cranked engine, the apparatus comprising battery connection, a voltage increase circuit having an electrical input and an electrical output, and electrical energy storage, wherein the apparatus is configured such that the battery connection is in electrical connection with the electrical input of the voltage increase circuit, and the electrical energy storage is in electrical connection with the electrical output of the voltage increase circuit such that electrical energy at a relatively low voltage from a battery connected to the battery connection flows to the voltage increase circuit which increases the voltage of the electrical energy to a relatively high voltage, and the electrical energy flows to the electrical energy storage and is stored therein at the relatively high voltage, and
the electrically cranked engine, the electrically cranked engine comprising a starter motor and the battery, the system configured to allow electrical connection of the starter motor and the battery with the electrical energy storage of the apparatus.

24. (canceled)
